(19) United States
(12) Patent Application Publication
(10) Pub. No.: US 2006/0156051 A1
(43) Pub. Date: Jul. 13, 2006

(54) Module for reading a data carrier

(75) Inventors: Andreas Lotz, Asslar-Berghausen (DE); Michael Koch, Lutzellinden (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,972

(22) PCT Filed: Dec. 10, 2003
(86) PCT No.: PCT/IB03/06002

§ 371 Date: Feb. 21, 2006

(30) Foreign Application Priority Data
Dec. 20, 2002 (EP) 02102848.5

(51) Int. Cl. G06F 11/00

(52) U.S. Cl. 714/1

(57) ABSTRACT

A module for reading a data carrier, with a processor arrangement and a memory arrangement, • wherein the module is designed for incorporation in a data processing device, • wherein the data carrier comprises data sequences and information on the data sequences, and the data sequences are stored in a directory structure with a root directory and at least one subdirectory, and • wherein the processor arrangement is designed for—writing the information about a first subset of the data sequences present in the root directory into a first directory of the memory arrangement, and—writing the information about at least a second subset of the data sequences present in a subdirectory of the data carrier into a second directory of the memory arrangement.

The invention relates to a module for reading a data carrier, which module is designed for incorporation in a data processing device.

Modules are known which are designed for reading data carriers, in particular CDs, minidisks, or DVDs, and which are used in the automotive field for incorporation in a car radio. Such modules offer the advantage that the module can always be of the same construction independently of the requirements or wishes of the end users or the car radio manufacturers, for example relating to different fronts or controls. The car radio itself comprises inter alia the front (instrument panel) comprising controls and usually a display, the amplifier electronics, and a tuner unit for radio reception. Modules to be integrated in car radios must comply with stringent requirements such as a small constructional volume in spite of complicated mechanical elements, operation under major shocks and impacts and at high temperatures, and a defined heat balance. It is in particular the small constructional volume and the heat balance that usually do not allow complicated electronic components to be used in a module. Furthermore, the possibility of an information provision to the user is limited because of a display but is limited in its presentation possibilities.

Modules are known which render possible the reproduction of data sequences (for example audio data) in uncompressed form (for example audio data laid down on any audio CD complying with the Red Book standard) or in compressed form (for example MP3 audio data stored on CD-ROMs). The modem possibilities of manufacturing CDs on the computer, however, also result in CDs of complicated structure, in which uncompressed audio data sequences and ROM data sequence structures occur side by side. Audio data sequences with compressed contents may be present in the ROM data sequence structures, as may indeed data sequences without audio contents. The data sequences within a ROM data sequence structure are often laid down in complicated directory structures, which are similar to the directory structures on a computer.

It is an object of the present invention to improve a module as described above.

This object is achieved by means of a module for reading a data carrier, with a processor arrangement and a memory arrangement,
wherein the module is designed for incorporation in a data processing device,
wherein the data carrier comprises data sequences and information on the data sequences, and the data sequences are stored in a directory structure with a root directory and at least one subdirectory, and
wherein the processor arrangement is designed for
   writing the information about a first subset of the data sequences present in the root directory into a first directory of the memory arrangement, and
   writing the information about at least a second subset of the data sequences present in a subdirectory of the data carrier into a second directory of the memory arrangement.

The directory structure of a data carrier comprises the root directory and subdirectories. The root directory then is the data carrier itself. If a data carrier is read and data sequences are present at this level, these sequences will be laid down in the root directory. Subdirectories are data sequence structures which themselves do not represent a playable data sequence, but which typically in their turn comprise data sequences and further subdirectories.

The expression “processor arrangement” denotes the electronic components which are used for decoding, decompressing, and generally processing the data sequences that are read from a data carrier, and also for processing the received commands and for sending messages. A processor arrangement may comprise a plurality of components, for example a specific decoding processor and/or a programmable digital signal processor (DSP), as well as other associated electronic components. The term “memory arrangement” is understood to be at least a memory component or a plurality of memory components which are each disigned for the complete or partial, volatile or non-volatile storage of program data for a DSP and/or for storing intermediate data (for example information on the data sequences of the data carrier instantaneously present in the module), and/or other data.

A ROM data sequence structure is always regarded as a subdirectory, also if it comprises only a single data sequence, because each ROM data sequence structure requires a so-called Volume Descriptor, which describes the contents. A Volume Descriptor of a ROM data sequence complies with ISO 9660. Further subdirectories may be present in a ROM data sequence structure. The number of hierarchical levels is limited to eight in a ROM data sequence structure.

The advantage of such a module is that the items of information on the data sequences present in the root directory of a data carrier are all stored in a directory of the memory arrangement. The access to this directory enhances the clarity for the user as regards the nature of the data sequences he/she accesses. On the data carrier itself, these data sequences may be mixed in any manner desired with data sequence structures (for example ROM data sequence structures). It is a further advantage that the information on each data sequence that is laid down in a respective subdirectory can also be found in one respective directory in the memory arrangement.

It is particularly advantageous if the directories in the memory arrangement are at no more than one hierarchical level, because this shows the structure of the audio data sequences more clearly, and the memory can be small and may thus be designed inexpensively.

The invention also relates to a data carrier playback device, e.g. a car radio, in which a module as described is incorporated.

The various aspects of the invention will be explained in detail below with reference to embodiments and the drawing, in which:

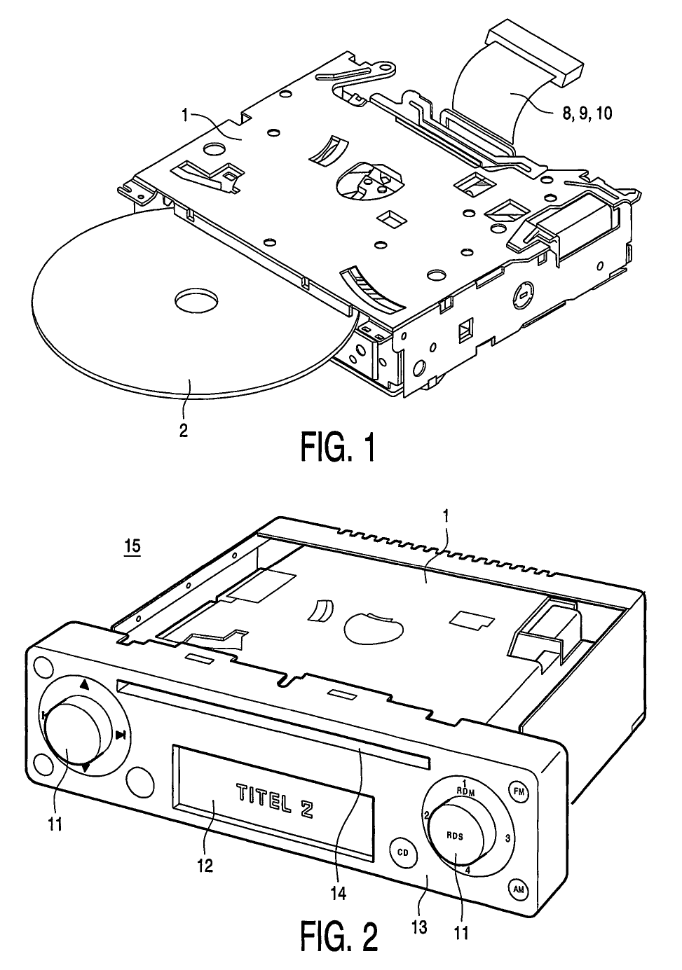

FIG. 1 shows a module for reading data carriers with a CD/DVD in the insertion/ejection compartment,

FIG. 2 shows a car radio which is designed for incorporation in the interior of an automobile and in which a module for reading data carriers is mounted,

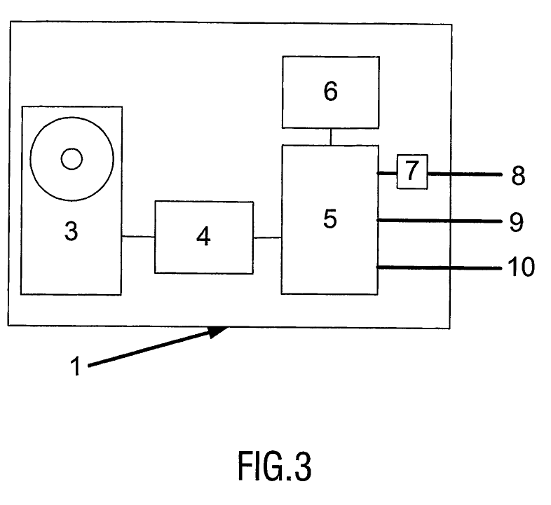

FIG. 3 is a block diagram of the internal construction of the module,

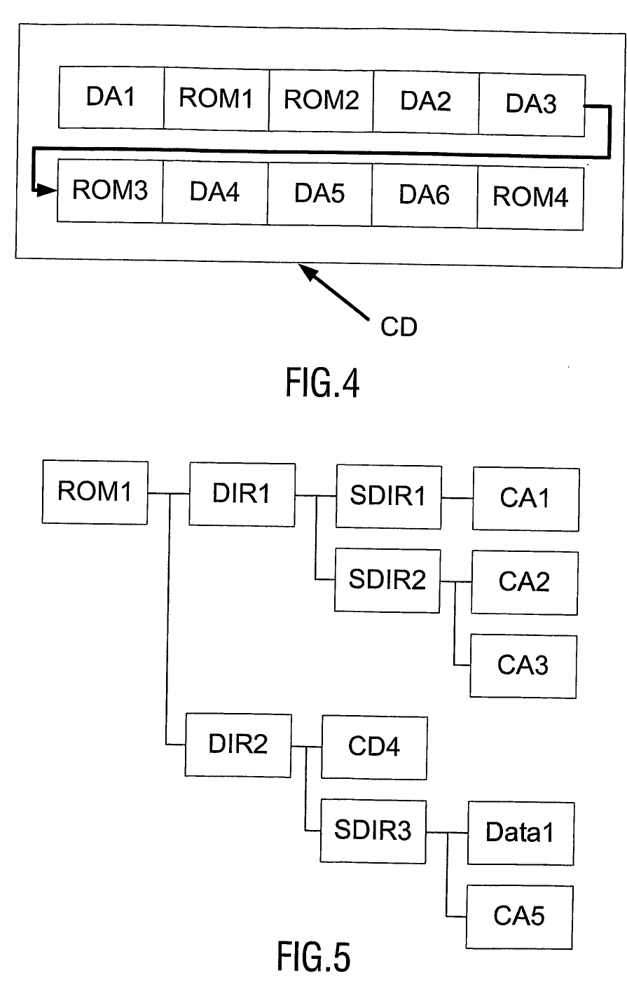

FIG. 4 shows by way of example the directory structure of a non-standard CD with uncompressed audio data sequences and ROM data sequence structures present thereon side by side,

FIG. 5 shows by way of example the internal directory structure of a ROM data sequence structure, in which audio data sequences with compressed contents and data sequences without audio contents are laid down in different subdirectories, and

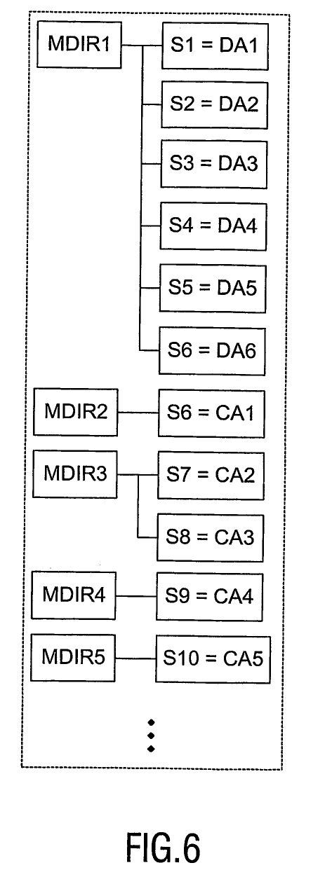

FIG. 6 diagrammatically shows how the information on the audio data sequences with uncompressed contents present in the root directory of the CD and the information on the audio data sequences with compressed contents present in the first ROM data sequence are stored in the directories of the memory arrangement.

FIG. 1 shows a module 1 for reading data carriers 2, which module has a data carrier 2 in its insertion/ejection compartment. Such a module is designed for being incorporated in a car radio. Lines 8, 9, 10 (here shown as a flat cable with a plug connector) are provided for the power supply and data exchange and are coupled to the car radio. The disc-shaped data carrier 2 (a CD/DVD in this case) is transported to a drive unit by mechanical elements (not shown) and is rotated thereon, such that a radially movable data pick-up is capable of reading data sequences present in spiraling pit structures on the CD/DVD.

FIG. 2 shows a car radio 15 which is designed for incorporation in the instrument panel of an automobile. The car radio 15 has a front 13 with controls 11, a display 12, and a slot 14. The module 1 is integrated in the car radio 15, which may be realized by means of screwing or locking or other known mounting methods. The module is integrated such that the insertion/ejection compartment of the module corresponds to the slot 14 of the car radio 15. A user may carry out simple or complicated operational actions by means of the controls 11, which then leads to an exchange of commands from the car radio 15 to the module 1. The module 1 supplies messages on its state, on errors, and on the processing of commands in return, which messages can be shown on the display 12.

FIG. 3 is a block diagram of the internal construction of a module 1 for reading CDs or DVDs. The drive unit 3 proper is formed by the drive for rotating the CD/DVD, the optical data pick-up unit with a laser diode, lenses, and lens actuators for adjusting the focusing and tracking, a photodiode array for the multiple-field measurement for determining the focusing and tracking quality, and a radial drive for the data pick-up unit. The decoder IC 4 (for example a Philips PhonIC) decodes the read data (for example EFM demodulation and error correction) and carries out an error interpolation, if necessary, and also controls the lens actuators for safeguarding an optimum focusing and tracking on the basis of the values of the multiple-field measurement. In the embodiment shown, the processor arrangement comprises the decoder IC 4, a DSP 5 (for example a DA 150 from TI) for digital data processing, and a digital/analog converter unit 7. The necessary programs for the DSP 5 are stored in a non-volatile manner in the memory arrangement 6 and are loaded into the DSP 5 upon switching-on of the module. Furthermore, new or updated programs may be read from a CD-ROM and may be stored in the memory arrangement 6.

The power supply and the communication with and control by the car radio are served by several lines 8, 9, 10, for example a I²S bus (Inter-IC-Sound), a I²C bus (Inter-IC-Communication), an S/P-DIF (Sony/Philips Digital Interface) output, analog outputs (for the respective left and right audio channels) for the transmission of digital/analog-converted audio data, and a power supply line. The I²S and I²C buses are serial buses with one or several clock lines for ensuring synchronization. As is shown in FIG. 1, the totality of all lines may be realized as a flat cable with a plug connector.

On an audio CD, audio data are laid down consecutively on a spiraling track from the inside to the outside (this relates either to the process of manufacturing an audio CD, for example with molded pits, or a corresponding writing process on a CD-R or CD-RW for the manufacture of an audio CD). A table of contents (TOC), in which information is laid down on the CD and on the individual audio data sequences, is present before the start of the actual audio data on the CD. In this TOC, for example, the absolute moment of the start of each audio data sequence can be found. This start time information is given in minutes (min), seconds (s), and frames (fra), one frame being one seventy-fifth of a second. A frame on a standard audio CD is composed of 98 fundamental 588-bit frames. Consecutive audio data are first interleaved and subsequently error-coded by the CIRC method. Eight control bits are added to each block of 192 payload data bits and 64 error correction bits in this case. Such a data block is subjected to an Eight-to-Fourteen Modulation (EFM) in which each eight-bit word is converted into a fourteen-bit word. Three coupling bits are joined to each fourteen-bit word, and finally each fundamental frame is provided with 24 synchronization bits, which results in a total of 588 bits. The information (min, s, fra) is also denoted a pointer, because the start of a data sequence can be unequivocally defined thereby (the time information in min, s, fra is incorporated in 98 control bits in each frame). Furthermore, the running time information for each audio data sequence can be found in the TOC.

Compressed audio data and playlists are laid down on a CD in the CD-ROM standard (Yellow Book Standard). Since it should be possible to reconstruct ROM data fully also in the case of minor scratches on the CD, there is an additional coding in addition to the channel coding described above. Instead of 192 payload data bits, blocks (sectors) of 2048 payload data bits are defined, which lead to a total of 2352 bytes per sector in combination with error correction data and other additional information. This corresponds to the payload data bits of 98 fundamental frames. The 2352 bytes of a sector are subdivided into 98 fundamental frames, as are the audio data, and are subjected to the same error coding and EFM, so that CD-ROM data can work with a double error correction. A ROM data sequence is characterized as such in the TOC of the CD. There is only one ROM data sequence on a standard CD-ROM. A ROM data sequence then comprises usually several data sequences arranged in a hierarchical structure, however, these are not indicated in the TOC of the CD.

FIG. 4 shows by way of example the structure of a non-standard CD. Data sequences with uncompressed audio contents (DA1, DA2, . . . ) and data sequence structures (ROM1, ROM2, . . . ) are present on this CD side by side. Such CDs can be manufactured with present-day computer programs.

FIG. 5 shows by way of example the structure of the ROM data sequence structure ROM1. The information on the structure and the data sequences can be found in the Volume Descriptor of the data sequence structure. ROM1 comprises two directories DIR1 and DIR2. Two subdirectories SDIR1 and SDIR21 are present in DIR1, such that a data sequence CA1 with compressed audio content is stored in SDIR1 and two data sequences CA2 and CA3 with compressed audio contents are stored in SDIR2. A data sequence CA4 and a subdirectory SDIR3 are present in the directory DIR2, while two data sequences Data1 and CA5 are stored in SDIR3, Data1 being a ROM data sequence without audio content.

FIG. 6 shows how the information on the data sequences is arranged in directories in the memory 6. This is shown here for the uncompressed data sequences and the data sequences with compressed audio contents of the data sequence structure ROM1. The information on data sequences from the other data sequence structures ROM2, ROM3 and ROM4 of the CD shown by way of example in FIG. 4 is stored in consecutive directories in the memory in a manner corresponding to the one to be described below.

The first directory MDIR1 contains the information on the uncompressed audio data sequences DA1-DA6, which occur mixed on the CD. It is achieved thereby that the information on the first subset of data sequences stored on the CD itself (i.e. in the root directory of the CD) can be found in one directory. This provides a better overview. In a second directory MDIR2, there is only the information S6 on the data sequence CA1. CA1 is the first data sequence that was found in a directory in the data sequence structure. This directory contained no further data sequences, so MDIR2 does not contain any further information on other data sequences either. This achieves that the information on data sequences that can be found in a directory on the CD can also be found in a directory in the memory of the module. The directory SDIR1, in which CA1 is stored, itself is a subdirectory of DIR1, which is a directory of ROM1. Nevertheless, S6 is stored in a directory MDIR2 which is parallel to MDIR1. It is achieved thereby that complicated directory structures are disentangled in the memory of the module, and the information on the data sequences is offered at a single hierarchical level. This simplifies the overview and saves memory space.

1. A module for reading a data carrier, with a processor arrangement and a memory arrangement,
wherein the module is designed for incorporation in a data processing device,
wherein the data carrier comprises data sequences and information on the data sequences, and the data sequences are stored in a directory structure with a root directory and at least one subdirectory, and
wherein the processor arrangement is designed for
writing the information about a first subset of the data sequences present in the root directory into a first directory of the memory arrangement, and
writing the information about at least a second subset of the data sequences present in a subdirectory of the data carrier into a second directory of the memory arrangement.

2. A module as claimed in claim 1, characterized in that the directories in the memory arrangement are arranged at not more than one hierarchical level.

3. A module as claimed in claim 1, characterized in that the data sequences of the first subset are audio data sequences with uncompressed audio contents, and the data sequences of the second subset are audio data sequences with compressed audio contents.

4. A module as claimed in claim 1, characterized in that the processor arrangement is designed for receiving commands demanding the information on the data sequences stored in the memory arrangement and for making said information available.

5. A module as claimed in claim 1, characterized in that the data processing device is a car radio.

6. A data carrier playback device, in which a module according to one of claims 1-5 is incorporated.
